(19) United States
(12) Patent Application Publication
(10) Pub. No.: US 2026/0169235 A1
(43) Pub. Date: Jun. 18, 2026

(54) OPTICAL RECEPTACLE MAIN BODY, OPTICAL RECEPTACLE, OPTICAL MODULE, AND METHOD OF MANUFACTURING OPTICAL MODULE

(71) Applicant: Enplas Corporation, Kawaguchi-shi (JP)

(72) Inventor: Ayano HINATA, Kawaguchi-shi (JP)

(73) Assignee: Enplas Corporation, Kawaguchi-shi (JP)

(21) Appl. No.: 19/416,008

(22) Filed: Dec. 11, 2025

(30) Foreign Application Priority Data
Dec. 12, 2024 (JP) 2024-217480

(51) Int. Cl. G02B 6/42; G02B 6/36

(52) U.S. Cl. CPC G02B 6/4214; G02B 6/3636; G02B 6/4206; G02B 6/423; G02B 6/4239; G02B 6/4244

(57) ABSTRACT

An optical receptacle main body according to the present invention is an optical receptacle main body for constituting an optical receptacle that optically couples an optical transmission member and a photoelectric conversion element mounted on a substrate, the optical receptacle main body including a groove for disposing the optical transmission member, in which the groove is disposed in a substrate-side surface of the optical receptacle main body that faces the substrate when the optical receptacle main body is disposed with respect to the substrate.

### RELATED APPLICATION(S)

This application claims the benefit of priority of Japanese Patent Application No. 2024-217480 filed on Dec. 12, 2024, the contents of the above application are all incorporated by reference as if fully set forth herein in their entirety.

### TECHNICAL FIELD

The present invention relates to an optical receptacle main body, an optical receptacle, an optical module, and a method of manufacturing an optical module.

### BACKGROUND ART

Conventionally, an optical receptacle for optically connecting an optical transmission member (for example, an optical fiber) to a photoelectric conversion element disposed on a substrate is known. For example, Patent Literature (hereinafter, referred to as “PTL”) 1 discloses such an optical receptacle.

### CITATION LIST

### Patent Literature

### PTL 1

Japanese Patent Application Laid-Open No. 2019-082508

### SUMMARY OF INVENTION

### Technical Problem

FIG. 1A is a sectional view showing a state in which optical transmission members 20 disposed in optical receptacle 10 as described above and photoelectric conversion element 40 mounted on substrate 30 are optically coupled to each other. Light from optical transmission members 20 is optically controlled by optical receptacle 10 and reaches photoelectric conversion element (light-receiving element) 40. On the other hand, light from the photoelectric conversion element (light-emitting element) 40 is optically controlled by optical receptacle 10 and reaches optical transmission members 20. In such optical receptacle 10, optical transmission members 20 are disposed in grooves 11 of optical receptacle 10 and is held such that the disposed optical fiber is pressed by a pressing member.

It is desirable that optical receptacle 10 as described above is disposed such that an optical surface for controlling light with respect to photoelectric conversion element 40 mounted on the substrate faces a predetermined position with high accuracy. Here, when optical receptacle 10 is disposed, optical receptacle 10 may be picked up and disposed by suctioning an upper surface of optical receptacle 10, but the pickup also needs to be performed with high accuracy. However, because optical receptacle 10 as described above includes pressing member 12 on an upper surface side to be suctioned, it is difficult to suction it. Therefore, it is difficult to pick up optical receptacle 10 with high accuracy. In a case where optical receptacle 10 cannot be picked up with high accuracy, it may be difficult to dispose the optical surface of optical receptacle 10 at a predetermined position with respect to the substrate with high accuracy.

An object of the present invention is to provide an optical receptacle main body, an optical receptacle including the optical receptacle main body, and an optical module including the optical receptacle, which are easy to pick up by suction. Another object of the present invention is to provide a method of manufacturing the optical module.

### Solution to Problem

The present invention relates to an optical receptacle main body, an optical receptacle, an optical module, and a method of manufacturing an optical module.
[1] An optical receptacle main body for forming an optical receptacle for optical coupling between an optical transmission member and a photoelectric conversion element mounted on a substrate, the optical receptacle main body including: a groove in which the optical transmission member is to be disposed, in which the groove is disposed in a substrate-side surface of the optical receptacle main body that faces the substrate when the optical receptacle main body is disposed with respect to the substrate.
[2] The optical receptacle main body according to [1], further including: a first optical surface configured to allow light from an end surface of the optical transmission member to enter the optical receptacle main body or allow light traveling inside the optical receptacle main body to be emitted toward the end surface of the optical transmission member; and a second optical surface configured to allow light from the photoelectric conversion element to enter an inside of the optical receptacle main body or allow light traveling inside the optical receptacle main body to be emitted toward the photoelectric conversion element, in which the second optical surface is disposed on the substrate-side surface.
[3] The optical receptacle main body according to [2], further including: a reflective surface configured to reflect light incident on the first optical surface toward the second optical surface or reflect light incident on the second optical surface toward the first optical surface.
[4] The optical receptacle main body according to any one of [1] to [3], further including: a positioning section disposed on the substrate-side surface and configured to position the optical receptacle main body with respect to the substrate.
[6] The optical receptacle main body according to any one of [2] to [4], further including: a recessed portion disposed in the substrate-side surface, in which the second optical surface is disposed within the recessed portion.
[6] The optical receptacle main body according to any one of [1] to [5], further including: a suctioned portion that is disposed on a surface opposite to the substrate-side surface and that is to be suctioned when the optical receptacle is moved.
[7] An optical receptacle, including: the optical receptacle main body according to any one of [1] to [6]; and a pressing member for pressing the optical transmission member toward the groove.
[8] The optical receptacle according to [7], in which the pressing member is formed of an ultraviolet transmitting material.
[9] An optical module, including: a substrate; a photoelectric conversion element mounted on the substrate; and the optical receptacle according to [7] or [8] that is mounted on the substrate.
[10] A method of manufacturing the optical module according to [9], the method including: preparing the optical receptacle according to [7] or [8] in which the optical transmission member is disposed between the groove and the pressing member; and moving the prepared optical receptacle to a predetermined position with respect to the substrate by suctioning a surface opposite to the substrate-side surface.

### Advantageous Effects of Invention

According to the present invention, it is possible to provide an optical receptacle main body that is easy to pick up by suction, an optical receptacle including the optical receptacle main body, and an optical module including the optical receptacle. According to the present invention, it is possible to provide a method of manufacturing the optical module.

### BRIEF DESCRIPTION OF DRAWINGS

FIG. 1A is a sectional view of a conventional optical module;

FIG. 1B is a sectional view of an optical module according to an embodiment;

FIG. 2 is a flowchart showing a method of manufacturing the optical module according to the embodiment;

FIGS. 3A to 3C are diagrams showing a configuration of an optical receptacle according to the embodiment;

FIGS. 4A to 4C are diagrams showing a configuration of an optical receptacle main body according to the embodiment; and

FIGS. 5A to 5C are diagrams showing a configuration of the optical receptacle main body according to the embodiment.

### DESCRIPTION OF EMBODIMENTS

### Configuration of Optical Module

Hereinafter, the optical module according to the embodiment of the present invention will be described in detail with reference to the accompanying drawings.

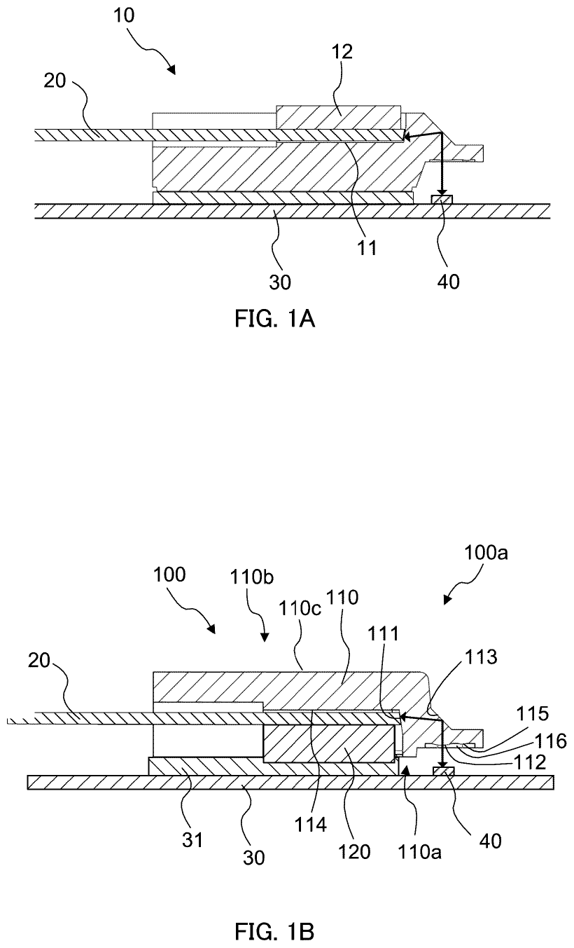

FIG. 1B is a sectional view showing optical module 100a according to the embodiment of the present invention. The sectional view is a sectional view taken perpendicularly to substrate 30 and along an extending direction of the optical transmission member. Optical module 100a in FIG. 1B includes substrate 30, photoelectric conversion element 40 mounted on substrate 30, and optical receptacle 100 mounted on substrate 30. In addition, optical receptacle 100 includes optical receptacle main body 110 and pressing member 120, and optical transmission members 20 are disposed between optical receptacle main body 110 and pressing member 120. Optical receptacle main body 110 includes first optical surface 111, second optical surfaces 112, reflective surface 113, and grooves 114.

Optical module 100a may be used as transmission-side optical module 100a as in the related art, or may be used as reception-side optical module 100a.

In a case where optical module 100a is used as reception-side optical module 100a, light emitted from end surface of optical transmission member 20 is incident on optical receptacle main body 110 at first optical surface 111, is reflected by reflective surface 113 and travels in optical receptacle main body 110, and is emitted from optical receptacle main body 110 at second optical surface 112 to reach photoelectric conversion element 40. In this case, photoelectric conversion element 40 functions as a light-receiving element.

In a case where optical module 100a is used as transmission-side optical module 100a, light emitted from photoelectric conversion element 40 mounted on substrate 30 is incident on optical receptacle 100 at second optical surface 112, is reflected by reflective surface 113 and travels in optical receptacle main body 110, and is emitted from optical receptacle 100 at first optical surface 111 to reach the end surface of optical transmission member 20. In this case, photoelectric conversion element 40 functions as a light-emitting element.

As shown in FIG. 1B, when optical receptacle main body 110 of optical receptacle 100 according to the embodiment of the present invention is disposed with respect to substrate 30, second optical surfaces 112 and grooves 114 in which optical transmission members 20 are disposed are disposed on substrate-side surface 110a facing substrate 30. In addition, pressing member 120 that presses optical transmission members 20 with respect to grooves 114 is disposed on substrate-side surface 110a. That is, pressing member 120 is disposed between substrate 30 and optical receptacle main body 110. Therefore, pressing member 120 is not provided on a surface (hereinafter, appropriately referred to as opposite-side surface 110b) of optical receptacle main body 110 opposite to substrate-side surface 110a. Therefore, optical receptacle 100 is easy to pick up by suction.

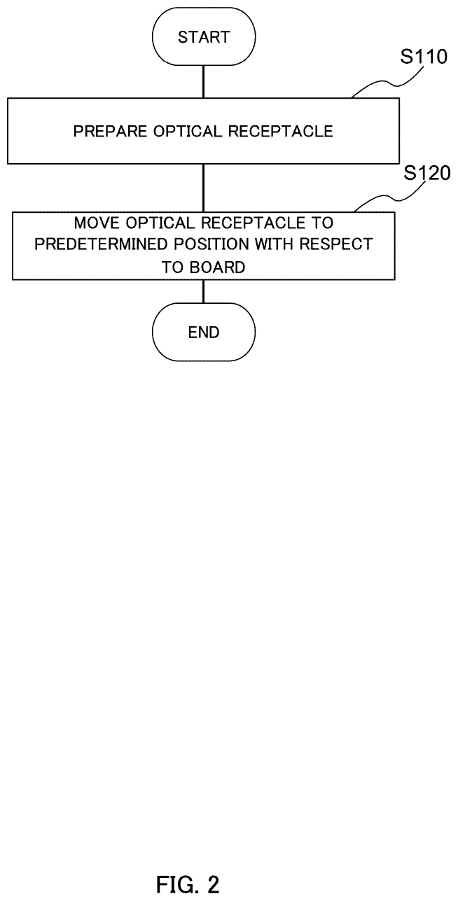

FIG. 2 is a flowchart showing a method of manufacturing optical module 100a. As shown in FIG. 2, the manufacturing method includes a step (S110) of preparing an optical receptacle in which optical transmission members 20 are disposed, and a step (S120) of moving the prepared optical receptacle to a predetermined position with respect to the substrate. Hereinafter, each of the steps will be described.

The step (S110) of preparing optical receptacle 100 in which optical transmission members 20 are disposed is performed as follows. First, optical transmission members 20 are disposed in grooves 114 of optical receptacle main body 110. Next, optical transmission members 20 are pressed with respect to grooves 114 by pressing member 120. Next, an adhesive is applied to optical transmission members 20 disposed in grooves 114. Next, the adhesive is cured. In this manner, optical receptacle 100 in which optical transmission members 20 are disposed can be prepared. The step of preparation may be performed through the steps as described above, or optical receptacle 100 in which optical transmission members 20 are disposed may be prepared in advance. The adhesive is not particularly limited as long as optical transmission members 20 can be adhered and held between grooves 114 and pressing member 120. Examples of the adhesive include an ultraviolet curable adhesive.

The step (S120) of moving prepared optical receptacle 100 to a predetermined position with respect to substrate 30 is performed as follows. First, opposite-side surface 110b of prepared optical receptacle 100 is suctioned by a suction apparatus to pick up the optical receptacle. Optical receptacle 100 according to the present embodiment does not have pressing member 120 on opposite-side surface 110b. Therefore, as described above, the optical receptacle is easy to pick up.

Next, the picked-up optical receptacle is moved to a predetermined position on the substrate. Specifically, it is preferable that the optical receptacle is moved and positioned such that second optical surface 112 of optical receptacle main body 110 is aligned to photoelectric conversion element 40. Since adhesive 31 is applied in advance on substrate 30, optical receptacle 100 can be fixed to the substrate and mounted by curing adhesive 31 after disposed. Adhesive 31 is not particularly limited as long as optical receptacle 100 can be adhered to substrate 30. Examples of the adhesive include an ultraviolet curable adhesive. When picked up, opposite-side surface 110b is on an upper side in a gravity direction, and substrate-side surface 110a is on a lower side in the gravity direction.

Hereinafter, details of each configuration will be described.

### Substrate

Substrate 30 is not particularly limited as long as photoelectric conversion element 40 and optical receptacle 100 can be mounted. Here, the mounting includes a case where photoelectric conversion element 40 is directly disposed on substrate 30 and a case where photoelectric conversion element 40 is disposed via another member. Similarly, the mounting includes a case where optical receptacle 100 is directly disposed on substrate 30 and a case where optical receptacle 100 is disposed via another member. For example, as shown in FIG. 1B, optical receptacle 100 is disposed on substrate 30 via cured adhesive 31 and is thus mounted on substrate 30. Examples of substrate 30 include a glass composite substrate, a glass epoxy substrate, and a flex circuit substrate.

### Photoelectric Conversion Element

Photoelectric conversion element 40 is a light-emitting element and/or a light-receiving element. Photoelectric conversion element 40 is, for example, a vertical cavity surface emitting laser (VCSEL) or a photodiode. The number of photoelectric conversion elements 40 is not particularly limited and may be one ora plurality, selected to match the number of second optical surfaces 112 of optical receptacle main body 110. In the present embodiment, the number of photoelectric conversion elements 40 is a pluralitye (four).

### Optical Transmission Member

The type of optical transmission members 20 is not particularly limited. Examples of the type of optical transmission members 20 include an optical fiber and an optical waveguide. The number of optical transmission members 20 is not particularly limited, and may be one or a plurality selected to match the number of second optical surfaces 112 of optical receptacle main body 110. In the present embodiment, the number of optical transmission members 20 is a plurality(four).

### Configuration of Optical Receptacle

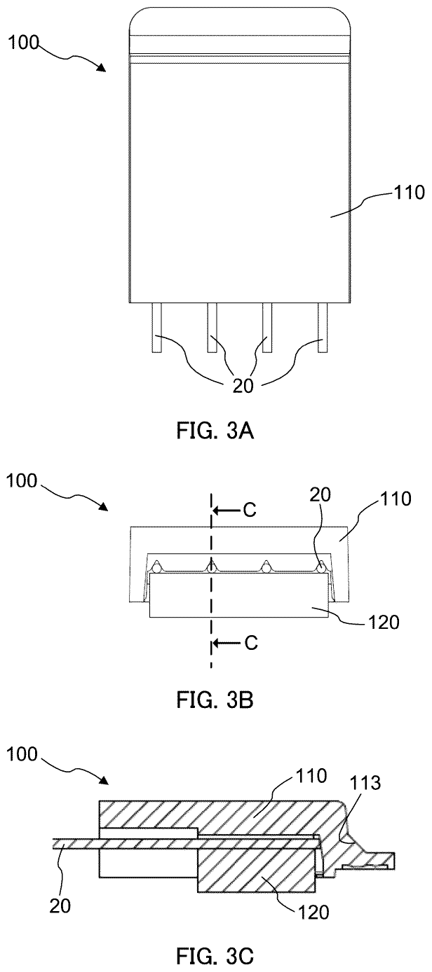

FIG. 3A is a plan view of optical receptacle 100 in which optical transmission members 20 are disposed, FIG. 3B is a rear view, and FIG. 3C is a sectional view taken along a C-C line of FIG. 3B.

As shown in FIGS. 3B and 3C, optical receptacle 100 includes optical receptacle main body 110 and pressing member 120. Optical receptacle main body 110 is formed of a material having light transmittance with respect to light (transmission light and reception light) used for optical communication. Examples of such a material include transparent resins such as polyetherimide (PEI) and cyclic olefin resin. In addition, it is preferable that optical receptacle main body 110 and pressing member 120 are manufactured by injection molding.

In addition, each of optical receptacle main body 110 and pressing member 120 can be formed of a material that does not transmit ultraviolet rays or can be formed of an ultraviolet transmitting material, but it is preferable that pressing member 120 is formed of an ultraviolet transmitting material. As a result, ultraviolet light can be transmitted through pressing member 120 to irradiate an ultraviolet curable adhesive in a state where optical receptacle 100 is placed on substrate 30 via the ultraviolet curable adhesive, and accordingly the ultraviolet curable adhesive can be easily cured. Examples of the ultraviolet transmitting material include an ultraviolet transmitting resin, glass, and the like.

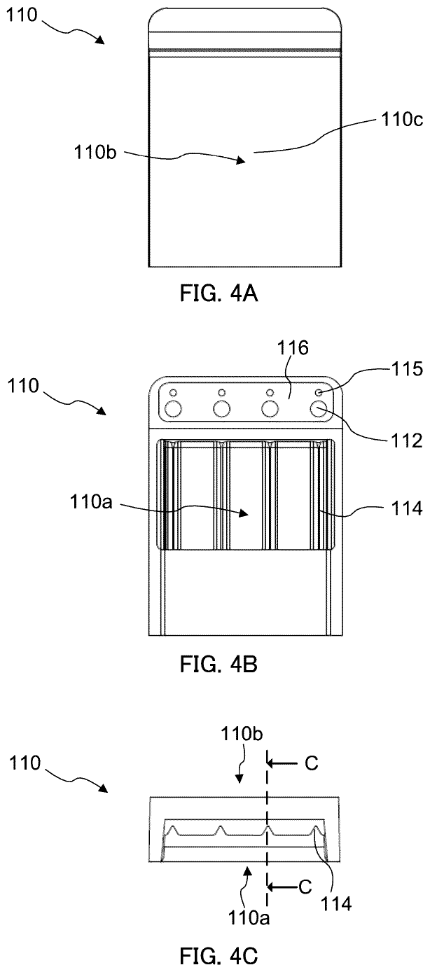

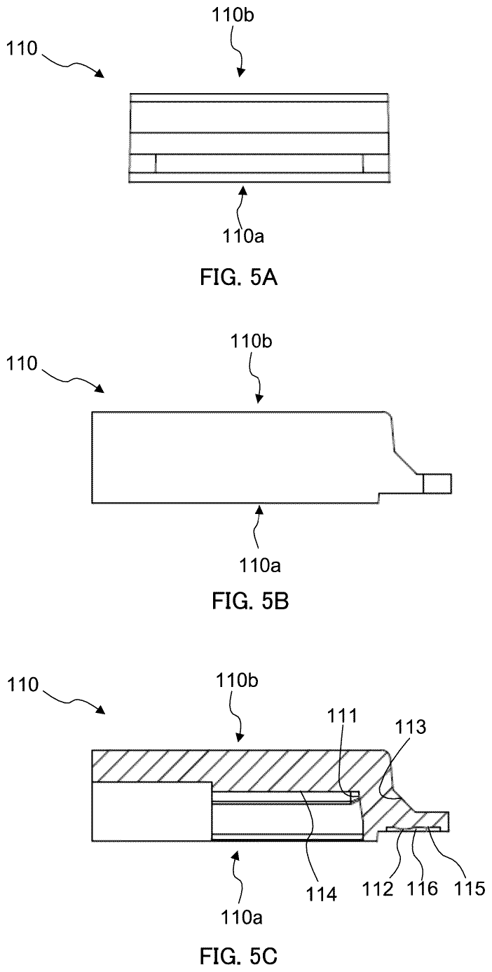

FIGS. 4A to 5C are diagrams showing a configuration of optical receptacle main body 110. FIG. 4A is a plan view as viewed from opposite-side surface 110b of optical receptacle main body 110, and FIG. 4B is a bottom view as viewed from substrate-side surface 110a. FIG. 4C is a rear view of optical receptacle main body 110, FIG. 5A is a front view, FIG. 5B is a side view, and FIG. 5C is a sectional view taken along a C-C line of FIG. 4C.

Hereinafter, details of each configuration of optical receptacle main body 110 will be described.

### First Optical Surface

First optical surface 111 allows light incident on second optical surface 112 to be emitted toward the end surfaces of optical transmission members 20 or allows light emitted from the end surfaces of optical transmission members 20 to be incident on first optical surface 111.

First optical surface 111 is not particularly limited as long as it can exhibit the above-described function. In the present embodiment, first optical surface 111 is a flat surface and is in contact with the end surfaces of optical transmission members 20. First optical surface 111 is disposed on substrate-side surface 110a of optical receptacle main body 110. A size of first optical surface 111 may be appropriately adjusted in accordance with the number of optical transmission members 20. In the present embodiment, first optical surface 111 is an elongated flat surface in a direction in which optical transmission members 20 are arranged, corresponding to four arranged optical transmission members 20.

### Second Optical Surface

Second optical surfaces 112 allow light emitted from photoelectric conversion element 40 to be incident on second optical surfaces 112 or allow light emitted from the end surfaces of optical transmission members 20 and transmitted through the inside of optical receptacle 100 to be emitted toward photoelectric conversion element 40. Second optical surfaces 112 are disposed on substrate-side surface 110a.

Second optical surfaces 112 are not particularly limited as long as it can exhibit the above-described function. Second optical surfaces 112 may be a flat surface or a curved surface. In the present embodiment, second optical surfaces 112 are a curved surface and are a convex lens that is convex toward photoelectric conversion element 40.

In the present embodiment, as shown in FIG. 4B, second optical surfaces 112 are disposed within recessed portion 116 disposed in substrate-side surface 110a. As a result, second optical surfaces 112 are prevented from being damaged. The number of second optical surfaces 112 is not particularly limited and may be one or a plurality, depending on the number of photoelectric conversion elements 40. In the present embodiment, the number of second optical surfaces 112 is a plurarity (four).

### Reflective Surface

Reflective surface 113 is disposed on an optical path between first optical surface 111 and second optical surface 112, and reflects light from first optical surface 111 toward second optical surface 112 or reflects light from second optical surface 112 toward first optical surface 111. Optical receptacle main body 110 may or may not include reflective surface 113.

Reflective surface 113 may be a flat surface or a curved surface. Reflective surface 113 may have a light focusing function or a light diffusing function by being a curved surface. Specifically, reflective surface 113 may reflect light from second optical surfaces 112 toward first optical surface 111 to focus the light. In addition, reflective surface 113 may reflect light from first optical surface 111 toward second optical surfaces 112 to focus the light. In the present embodiment, reflective surface 113 is a flat surface and is an inclined surface inclined with respect to substrate 30.

### Groove

Optical transmission members 20 are disposed in grooves 114. Grooves 114 are disposed in substrate-side surface 110a. Grooves 114 extend in a direction from a rear surface side of optical receptacle main body 110 to a front surface side. A cross-sectional shape of each of grooves 114 is not particularly limited as long as optical transmission members 20 can be disposed. The groove may be a U-shaped groove or a V-shaped groove. The number of grooves 114 is not particularly limited, and may be one or a plurality, depending on the number of optical transmission members 20. In the present embodiment, the number of grooves 114 is a plurality (four).

### Substrate-Side Surface

Substrate-side surface 110a is a surface (bottom surface) on a side facing substrate 30 when optical receptacle main body 110 is disposed with respect to substrate 30. Substrate-side surface 110a includes a surface (for example, a surface parallel to substrate 30) facing substrate 30. In addition, substrate-side surface 110a includes a step surface (for example, a surface perpendicular to substrate 30) that is positioned between two surfaces (for example, two surfaces parallel to substrate 30) facing the substrate and that connects the two surfaces. In the present embodiment, first optical surface 111, second optical surfaces 112, grooves 114, and positioning sections 115 are disposed on substrate-side surface 110a. In addition, in the present embodiment, when arranged in order of increasing distance to substrate 30 in a direction perpendicular to substrate 30, second optical surfaces 112, first optical surface 111, and grooves 114 (bottoms of grooves 114) are arranged in the order presented. That is, when optical receptacle main body 110 is disposed with respect to substrate 30, first optical surface 111 is located closer to the substrate 30 than grooves 114 (bottoms of grooves 114), and second optical surfaces 112 are located closer to the substrate 30 than the first optical surface 111.

### Opposite-Side Surface

Opposite-side surface 110b is a surface (top surface) on a side of optical receptacle main body 110 opposite to substrate-side surface 110a. opposite-side surface 110b is not provided grooves 114, on which pressing member 120 is not disposed. As a result, opposite-side surface 110b has a large area and is suitable as a surface to be suctioned. On opposite-side surface 110b, suctioned portion 110c can be set to any position that is easy to suction. Suctioned portion 110c can be set to a position and a range on opposite-side surface 110b at and within which optical receptacle 100 does not tilt with respect to substrate 30 when optical receptacle 100 is suctioned and picked up. The surface of opposite-side surface 110b may be a flat surface or a curved surface (convex surface or concave surface). In the present embodiment, opposite-side surface 110b is a flat surface. An area of opposite-side surface 110b can be set to an area larger than an area of a surface of pressing member 120 on the substrate 30 side. As a result, opposite-side surface 110b is suitable as a surface to be suctioned.

### Pressing Member

Pressing member 120 presses optical transmission members 20 toward grooves 114. Pressing member 120 is disposed on substrate-side surface 110a in optical module 100a, similarly to the grooves 114. Pressing member 120 is not particularly limited as long as optical transmission members 20 can be pressed. In the present embodiment, pressing member 120 has a rectangular parallelepiped shape. In addition, in the present embodiment, pressing member 120 has a size (thickness) such that the surface of pressing member 120 on the substrate 30 side protrudes toward substrate 30 side with respect to optical receptacle main body 110 when pressing member 120 is disposed to press optical transmission members 20 toward grooves 114. As a result, as shown in FIG. 1B, when optical receptacle 100 is mounted on substrate 30, optical receptacle 100 (optical receptacle main body 110) is mounted on substrate 30 via pressing member 120. It is preferable that pressing member 120 is formed of an ultraviolet transmitting material. As a result, when optical receptacle 100 is fixed to substrate 30 by the ultraviolet curable adhesive, the ultraviolet curable adhesive is easily cured by ultraviolet rays. Specifically, in substrate 30 on which optical receptacle 100 is mounted via the ultraviolet curable adhesive, the adhesive is easily cured by irradiation with ultraviolet rays from a direction substantially parallel to substrate 30.

### Positioning Section

As shown in FIG. 4B, optical receptacle main body 110 may include positioning sections 115. Positioning sections 115 are for positioning when optical receptacle 100 is mounted on substrate 30. Specifically, the position of optical receptacle 100 can be determined by disposing positioning sections 115 with respect to any mark on the substrate. Positioning sections 115 are not particularly limited as long as they can exhibit the above-described function. In the present embodiment, four positioning sections 115 are present to correspond to four second optical surfaces 112, and are disposed on substrate-side surface 110a. In the present embodiment, positioning sections 115 are disposed within recessed portion 116 like second optical surfaces 112. In addition, in the present embodiment, positioning sections 115 are protrusions having a circular planar shape.

### Effects

In optical receptacle 100 according to the embodiment of the present invention, pressing member 120 is not provided on opposite-side surface 110b, and opposite-side surface 110b has a large area. Therefore, optical receptacle 100 is easy to be picked up by suction and is unlikely to tilt. As a result, optical receptacle 100 can be mounted on substrate 30 at a predetermined position with high accuracy. In addition, in optical receptacle 100 according to the embodiment of the present invention, since grooves 114 and second optical surfaces 112 are visible from the same direction, it is possible to evaluate whether optical receptacle main body 110 is molded in a predetermined shape, by evaluating the positions of grooves 114 and second optical surfaces 112. In addition, it is possible to evaluate the positions of the optical transmission members disposed in grooves 114 in relation to second optical surfaces 112. These contribute to improving reliability of obtaining a desired optical coupling efficiency when optical receptacle 100 is mounted at a predetermined position of substrate 30. In addition, since pressing member 120 is formed of an ultraviolet transmitting material, substrate 30 is easily fixed by only the ultraviolet curable adhesive.

### INDUSTRIAL APPLICABILITY

The optical receptacle and the optical module according to the present invention are useful for, for example, optical communication using an optical transmission member.

### REFERENCE SIGNS LIST

100a Optical module
10, 100 Optical receptacle
12, 120 Pressing member
20 Optical transmission member
30 Substrate
31 Adhesive
40 Photoelectric conversion element
110 Optical receptacle main body
110a Substrate-side surface
110b Opposite-side surface
110c Suctioned portion
111 First optical surface
112 Second optical surface
113 Reflective surface
114 Groove
115 Positioning section
116 Recessed portion

1. An optical receptacle main body for forming an optical receptacle for optical coupling between an optical transmission member and a photoelectric conversion element mounted on a substrate, the optical receptacle main body comprising:
a groove in which the optical transmission member is to be disposed, wherein
the groove is disposed in a substrate-side surface of the optical receptacle main body that faces the substrate when the optical receptacle main body is disposed with respect to the substrate.

2. The optical receptacle main body according to claim 1, further comprising:
a first optical surface configured to allow light from an end surface of the optical transmission member to enter the optical receptacle main body or allow light traveling inside the optical receptacle main body to be emitted toward the end surface of the optical transmission member; and
a second optical surface configured to allow light from the photoelectric conversion element to enter an inside of the optical receptacle main body or allow light traveling inside the optical receptacle main body to be emitted toward the photoelectric conversion element,
wherein the second optical surface is disposed on the substrate-side surface.

3. The optical receptacle main body according to claim 2, further comprising:
a reflective surface configured to reflect light incident on the first optical surface toward the second optical surface or reflect light incident on the second optical surface toward the first optical surface.

4. The optical receptacle main body according to claim 1, further comprising:
a positioning section disposed on the substrate-side surface and configured to position the optical receptacle main body with respect to the substrate.

5. The optical receptacle main body according to claim 2, further comprising:
a recessed portion disposed in the substrate-side surface, wherein
the second optical surface is disposed within the recessed portion.

6. The optical receptacle main body according to claim 1, further comprising:
a suctioned portion that is disposed on a surface opposite to the substrate-side surface and that is to be suctioned when the optical receptacle is moved.

7. An optical receptacle, comprising:
the optical receptacle main body according to claim 1; and
a pressing member for pressing the optical transmission member toward the groove.

8. The optical receptacle according to claim 7, wherein
the pressing member is formed of an ultraviolet transmitting material.

9. An optical module, comprising:
a substrate;
a photoelectric conversion element mounted on the substrate; and
the optical receptacle according to claim 7 that is mounted on the substrate.

10. A method of manufacturing the optical module according to claim 9, the method comprising:
preparing the optical receptacle in which the optical transmission member is disposed between the groove and the pressing member; and
moving the prepared optical receptacle to a predetermined position with respect to the substrate by suctioning a surface opposite to the substrate-side surface.
